(19) United States
(12) Patent Application Publication
(10) Pub. No.: US 2026/0152092 A1
(43) Pub. Date: Jun. 4, 2026

(54) ELECTRIFIED VEHICLE

(71) Applicant: TOYOTA JIDOSHA KABUSHIKI KAISHA, Toyota-shi (JP)

(72) Inventor: Yosuke WADA, Nagakute-shi (JP)

(73) Assignee: TOYOTA JIDOSHA KABUSHIKI KAISHA, Toyota -shi (JP)

(21) Appl. No.: 19/288,342

(22) Filed: Aug. 1, 2025

(30) Foreign Application Priority Data
Dec. 4, 2024 (JP) 2024-211631

(51) Int. Cl. B60L 58/16; B60L 58/12

(52) U.S. Cl. CPC B60L 58/16; B60L 58/12; B60L 2240/547; B60L 2240/549

(57) ABSTRACT

An electrified vehicle includes a power storage device, a drive device, a relay, a voltage sensor that measures a voltage of the power storage device, a current sensor that measures a charging and discharging current of the power storage device, and a control unit. The control unit acquires a first open circuit voltage (OCV) when the relay is off. The control unit turns on the relay at least once, and then acquires a second OCV when the relay is turned off. The control unit calculates an integrated current value of the power storage device in a period from when the first OCV is acquired to when the second OCV is acquired, based on a measurement value from the current sensor. The control unit calculates full charge capacity of the power storage device based on the integrated current value, the first OCV, and the second OCV.

### CROSS-REFERENCE TO RELATED APPLICATION

This application claims priority to Japanese Patent Application No. 2024-211631 filed on Dec. 4, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

Conventionally, various types of methods have been proposed for estimating a full charge capacity of a battery that is installed in a vehicle. Japanese Unexamined Patent Application Publication No. 2008-261669 (JP 2008-261669 A) discloses a method for calculating a full charge capacity of a battery from a first open circuit voltage (hereinafter referred to as “first OCV”) before starting plug-in charging, a second open circuit voltage (hereinafter referred to as “second OCV”) after ending plug-in charging, and an integrated current value that is difference in battery capacity between the first OCV and the second OCV.

### SUMMARY

Now, when a user starts plug-in charging immediately after traveling of the vehicle, the full charge capacity is calculated based on the first OCV that includes influence of voltage drop due to polarization. As a result, estimation precision of the full charge capacity that is calculated based on the first OCV including the influence of voltage drop due to polarization is inferior to the estimation precision of the full charge capacity that is calculated based on the first OCV from which the influence of voltage drop due to polarization is removed. A method for estimating the first OCV taking into consideration polarization immediately after traveling is disclosed in, for example, Japanese Unexamined Patent Application Publication No. 2022-150523 (JP 2022-150523 A). However, when standby time from immediately after traveling until plug-in charging is short, the estimation precision of the first OCV taking polarization into consideration deteriorates, and the full charge capacity cannot be estimated with high precision.

Now, the inventor has confirmed that there are electrified vehicles that are left parked without being plugged in for charging even after traveling, such as when away from home, or the like. The inventor then conceived an idea of calculating the full charge capacity based on the OCV that is acquired before and after the vehicle traveling.

The present disclosure has been made to solve the above problems, and an object thereof is to provide an electrified vehicle that can suppress deterioration in the precision of estimating the full charge capacity, by estimating the full charge capacity based on the OCV before and after the vehicle traveling.

An electrified vehicle according to a first aspect of the present disclosure includes a power storage device that is installed in the electrified vehicle, a drive device that generates a driving force for traveling, using electric power that is supplied from the power storage device, a relay that is provided between the power storage device and the drive device, a voltage sensor that measures a voltage of the power storage device, a current sensor that measures a charging and discharging current of the power storage device, and a control unit. The control unit acquires a first open circuit voltage (OCV) when the relay is off. The control unit turns on the relay at least once, and then acquires a second OCV when the relay is turned off. The control unit calculates an integrated current value of the power storage device for a period from when the first OCV is acquired to when the second OCV is acquired, based on a measurement value from the current sensor. The control unit calculates full charge capacity of the power storage device based on the integrated current value, the first OCV, and the second OCV.

The control unit that is included in the electrified vehicle according to the first aspect of the present disclosure may acquire the second OCV after a first period elapses following the relay being turned off.

The control unit that is included in the electrified vehicle according to the first aspect of the present disclosure may acquire the first OCV again, when a second period elapses after acquiring of the first OCV.

The control unit that is included in the electrified vehicle according to the first aspect of the present disclosure may acquire the first OCV following the electrified vehicle ending plug-in charging.

The control unit that is included in the electrified vehicle according to the first aspect of the present disclosure may acquire the first OCV after a third period elapses following the electrified vehicle ending plug-in charging.

A current sensor that is provided in the electrified vehicle according to a second aspect of the present disclosure may be provided outside of the power storage device. The power storage device may include a power storage module. The control unit may store information regarding an internal current flowing in the power storage module. The control unit may calculate the full charge capacity of the power storage device based on the internal current, the integrated current value, the first OCV, and the second OCV.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an electrified vehicle according to an embodiment of the present disclosure;

FIG. 2 is a control flowchart of the electrified vehicle according to the embodiment of the present disclosure; and

FIG. 3 shows an example of a method for estimating a full charge capacity that is performed by the electrified vehicle according to the embodiment of the present disclosure.

### DETAILED DESCRIPTION OF EMBODIMENTS

Hereinafter, embodiments of the present disclosure will be described in detail with reference to the drawings. The same or corresponding parts are denoted by the same signs throughout the drawings, and description thereof will not be repeated.

### Overall Configuration of Electrified Vehicle

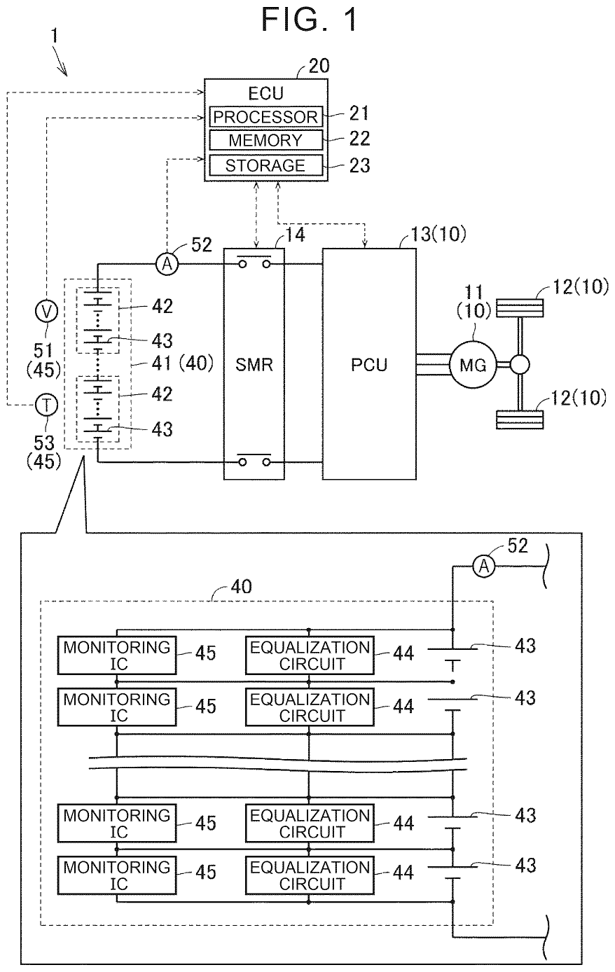

FIG. 1 is a schematic configuration diagram of an electrified vehicle according to an embodiment of the present disclosure.

An electrified vehicle 1 is, for example, a battery electric vehicle. The electrified vehicle 1 includes a drive device 10, a system main relay (SMR) 14, an electronic control unit (ECU) 20, a power storage device 40, a voltage sensor 51, a current sensor 52, and a temperature sensor 53. The ECU 20 is configured to be able to communicate with a power control unit (PCU) 13 that will be described later, the SMR 14, the voltage sensor 51, the current sensor 52, and the temperature sensor 53.

The drive device 10 is configured to be capable of generating driving force for traveling, using electric power that is supplied from the power storage device 40. The drive device 10 includes a motor generator (MG) 11 that is a rotating electric machine, drive wheels 12, and the PCU 13.

The MG 11 is, for example, an interior permanent magnet synchronous motor (IPM motor), and functions as an electric motor and as a generator. The output torque of the MG 11 is transmitted to the drive wheels 12 via a power transmission device that is configured including a reducer, a differential, and the like.

When the electrified vehicle 1 is braking, the MG 11 is driven by the drive wheels 12 and the MG 11 operates as a generator. Thus, the MG 11 also functions as a braking device that performs regenerative braking to convert the kinetic energy of the electrified vehicle 1 into electric power. Regenerative electric power that is generated by the regenerative braking force at the MG 11 is stored in the power storage device 40.

The PCU 13 is a power conversion device that converts electric power bidirectionally between the MG 11 and the power storage device 40. The PCU 13 includes, for example, an inverter and a converter that operate based on control signals from the ECU 20. When the power storage device 40 is discharging, the converter boosts voltage that is supplied from the power storage device 40 and supplies the boosted voltage to the inverter. The inverter converts direct current electric power that is supplied from the converter into alternating current electric power, to drive the MG 11. Note that the PCU 13 may be configured with the converter omitted therefrom.

The SMR 14 is provided between the power storage device 40 and the drive device 10. The SMR 14 is electrically connected to a power line that connects the power storage device 40 and the drive device 10. When the SMR 14 is closed (on) in response to a control signal from the ECU 20 (i.e., in a conducting state), electric power can be exchanged between the power storage device 40 and the PCU 13. On the other hand, when the SMR 14 is opened (off) in response to a control signal from the ECU 20 (i.e., in an interrupted state), the electrical connection between the power storage device 40 and the PCU 13 is interrupted. The SMR 14 is closed (on) when the ignition power of the electrified vehicle 1 is turned on, for example. The SMR 14 functions as a protection device during driving of the electrified vehicle 1. Note that the SMR 14 is an example of a “relay” in the present disclosure.

The ECU 20 includes a processor 21, memory 22, and storage 23. The processor 21 is a computation device such as a central processing unit (CPU), a microprocessor unit (MPU), or the like. The memory 22 is volatile memory (working memory) such as random access memory (RAM) or the like. The storage 23 is rewritable non-volatile memory, such as flash memory or the like. The storage 23 stores system programs including an operating system (OS) and control programs including computer-readable code that is necessary for control computation. The processor 21 reads out system programs and control programs, which are then loaded to the memory 22, and executed, in order to realize various types of processing. The ECU 20 stores voltage information that is acquired from the voltage sensor 51 and current information that is acquired from the current sensor 52, which will be described later, along with time information. The ECU 20 may be divided into a plurality of ECUs, in accordance with functions. Note that the ECU 20 is an example of a “control unit” in the present disclosure.

The power storage device 40 is installed in the electrified vehicle 1. The power storage device 40 has a battery pack 41. The battery pack 41 has a plurality of power storage modules 42. The power storage modules 42 are electrically connected in series. Each of the power storage modules 42 has a plurality of power storage cells 43. The power storage cells 43 are electrically connected in series. Each of the power storage cells 43 is a secondary battery such as a nickel metal hydride battery, a lithium-ion battery, or the like. A secondary battery is, for example, a battery that has a liquid electrolyte between a cathode and an anode. The power storage device 40 has an equalization circuit 44 that is provided to each of the power storage cells 43, and a monitoring integrated circuit (IC) 45 that is provided to each of the power storage cells 43. The equalization circuit 44 has discharge resistance. The equalization circuit 44 is used to equalize storage capacity of each of the power storage cells 43, for example. Each of the monitoring ICs 45 includes the voltage sensor 51 and the temperature sensor 53. Each of the monitoring ICs 45 is connected in parallel to each of the power storage cells 43, and is configured to be able to measure voltage and temperature of each of the power storage cells 43 and output measurement results to the ECU 20.

The voltage sensor 51 is configured to be able to measure voltage between terminals of the battery pack 41 and output measurement results to the ECU 20. Also, the voltage sensor 51 is configured to be able to measure the voltage of each of the power storage cells 43 and output the measurement results to the ECU 20.

The current sensor 52 is provided outside of the power storage device 40. The current sensor 52 is configured to be able to measure charging and discharging current of the battery pack 41 that is charged and discharged, and output measurement results to the ECU 20. When the battery pack 41 is discharging, for example, the current sensor 52 can use a positive value that is measured by the current sensor 52 as the current value. Also, when the battery pack 41 is charging, for example, the current sensor 52 can use a negative value that is measured by the current sensor 52 as the current value.

The temperature sensor 53 is configured to be able to measure temperatures of the power storage cells 43, and output measurement results to the ECU 20.

### Control Flow of Electrified Vehicle

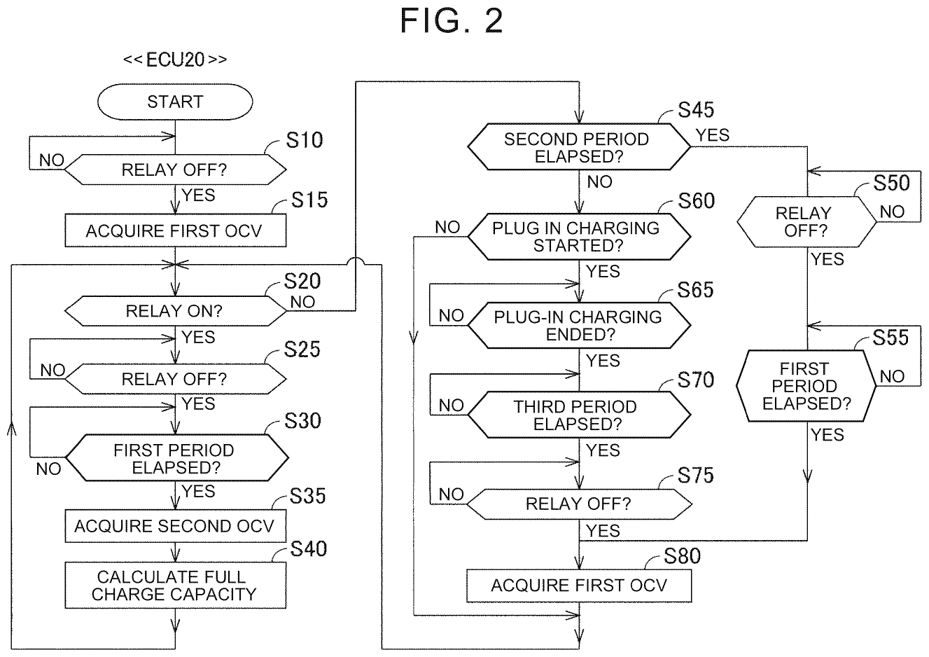

Next, a control flow for calculating full charge capacity that is performed by the electrified vehicle 1 will be described with reference to FIG. 2.

In step S10 that is shown in FIG. 2, the ECU 20 confirms whether the SMR 14 is open (off). When the SMR 14 is off (Yes in step S10), the processing of the ECU 20 proceeds to step S15. When the SMR 14 is not off (No in step S10), the ECU 20 performs the processing of step S10 again.

In step S15, the ECU 20 acquires a first OCV. More specifically, the ECU 20 stores the voltage information that is acquired from the voltage sensor 51 as the first OCV. Thereafter, the processing of the ECU 20 proceeds to step S20.

In step S20, the ECU 20 confirms whether the SMR 14 is closed (on). When the SMR 14 is on (Yes in step S20), the processing of the ECU 20 proceeds to step S25. When the SMR 14 is not on (No in step S20), the processing of the ECU 20 proceeds to step S45.

In step S25, the ECU 20 confirms whether the SMR 14 is off. When the SMR 14 is off (Yes in step S25), the processing of the ECU 20 proceeds to step S30. When the SMR 14 is not off (No in step S25), the ECU 20 performs the processing of step S25 again.

In step S30, the ECU 20 confirms whether a first period P1 has elapsed. Here, the first period P1 is a period from when the ECU 20 confirms in step S25 that the SMR 14 is off. When the first period P1 has elapsed after the processing of step S25 (Yes in step S30), the processing of the ECU 20 proceeds to step S35. After the processing of step S25, when the first period P1 has not elapsed (No in step S30), the ECU 20 performs the processing of step S30 again.

In step S35, the ECU 20 acquires a second OCV. More specifically, the ECU 20 stores the voltage information that is acquired from the voltage sensor 51 as the second OCV. Thereafter, the processing of the ECU 20 proceeds to step S40.

In step S40, the ECU 20 calculates the full charge capacity. More specifically, the ECU 20 calculates the full charge capacity of the battery pack 41 based on the first OCV, the second OCV, and an integrated current value. Here, the integrated current value is an integrated value of the charging and discharging current of the battery pack 41 from when the first OCV is acquired to when the second OCV is acquired. The ECU 20 calculates the integrated current value based on the measurement value that is output from the current sensor 52. Thereafter, the processing of the ECU 20 proceeds to step S20.

In step S45, the ECU 20 confirms whether a second period P2 has elapsed. Here, the second period P2 is a period from when the ECU 20 acquires the first OCV in step S15. The second period P2 is a period from two days to one week, for example. When the second period P2 has elapsed since the first OCV was acquired in step S45 (Yes in step S45), the processing of the ECU 20 proceeds to step S50. When the second period P2 has not elapsed since the first OCV was acquired in step S45 (No in step S45), the processing of the ECU 20 proceeds to step S60.

In step S50, the ECU 20 confirms whether the SMR 14 is off. When the SMR 14 is off (Yes in step S50), the processing of the ECU 20 proceeds to step S55. When the SMR 14 is not off (No in step S50), the ECU 20 performs the processing of step S50 again.

In step S55, the ECU 20 confirms whether the first period P1 has elapsed. Here, the first period P1 is a period from when the ECU 20 confirms in step S50 that the SMR 14 is off. When the first period P1 has elapsed after the processing of step S50 (Yes in step S55), the processing of the ECU 20 proceeds to step S80. When the first period P1 has not elapsed after the processing of step S50 (No in step S55), the ECU 20 performs the processing of step S55 again.

In step S60, the ECU 20 confirms whether the electrified vehicle 1 has started plug-in charging. When the electrified vehicle 1 has started plug-in charging (Yes in step S60), the processing of the ECU 20 proceeds to step S65. When the electrified vehicle 1 has not started plug-in charging (No in step S60), the ECU 20 performs the processing of step S20 again.

In step S65, the ECU 20 confirms whether the electrified vehicle 1 has ended plug-in charging. When the electrified vehicle 1 has ended plug-in charging (Yes in step S65), the processing of the ECU 20 proceeds to step S70. When the electrified vehicle 1 has not ended plug-in charging (No in step S65), the ECU 20 performs the processing of step S65 again.

In step S70, the ECU 20 confirms whether a third period P3 has elapsed. Here, the third period P3 is a period from when confirmation is made in step S65 that plug-in charging of the electrified vehicle 1 has ended. When the third period P3 has elapsed since confirmation is made in step S65 that the plug-in charging of the electrified vehicle 1 has ended (Yes in step S70), the processing of the ECU 20 proceeds to step S75. In step S70, when the third period P3, from confirmation that the plug-in charging of the electrified vehicle 1 has ended, has not elapsed (No in step S70), the ECU 20 performs the processing of step S70 again.

In step S75, the ECU 20 confirms whether the SMR 14 is off. When the SMR 14 is off (Yes in step S75), the processing of the ECU 20 proceeds to step S80. When the SMR 14 is not off (No in step S75), the ECU 20 performs the processing of step S75 again.

In step S80, the ECU 20 acquires the first OCV. More specifically, the ECU 20 stores the voltage information that is acquired from the voltage sensor 51 as the first OCV. When the ECU 20 has already stored the first OCV, the ECU 20 overwrites the existing first OCV information with the first OCV information that is acquired in step S80. Thereafter, the processing of the ECU 20 proceeds to step S20.

According to the control flow shown in FIG. 2, the ECU 20 of the electrified vehicle 1 according to the embodiment of the present disclosure estimates the full charge capacity of the battery pack 41. More specifically, in step S15, the ECU 20 acquires the first OCV when the SMR 14 is OFF. Thereafter, after the SMR 14 has been turned on and off at least once, i.e., after the ECU 20 has performed processing of steps S20 and S25, the second OCV is acquired. The ECU 20 then estimates the full charge capacity of the battery pack 41 based on the first OCV, the second OCV, and the integrated current value. Using this estimation method enables the electrified vehicle 1 to estimate the full charge capacity of the battery pack 41 based on the OCV that is acquired before and after the vehicle traveling.

In such a method for estimating the full charge capacity, the ECU 20 acquires the second OCV after the SMR 14 is turned off and the first period P1 has elapsed thereafter (after the processing of step S30). This enables the ECU 20 to acquire the OCV after polarization that is caused by the discharge current during traveling has been resolved. As a result, the full charge capacity can be estimated based on the OCV from which the influence of polarization has been excluded, and accordingly the precision of estimating the full charge capacity can be suppressed from deteriorating.

Here, the first period P1 is 30 minutes or 1 hour, for example. The ECU 20 may store a map indicating a relation between the temperature of the power storage cells 43 and polarization resolution time, and may select the first period P1 based on temperature information of the power storage cells 43 that are measured by the temperature sensor 53.

The battery pack 41 consumes electric power due to self-discharging and dark current, even during standby. As time passes from the first OCV being acquired, the amount of electric power consumption due to self-discharging and dark current increases. The electric power consumption amount due to self-discharging and dark current is electric power consumption that cannot be calculated from the voltage sensor 51 and the current sensor 52. As a result, the precision of estimating the full charge capacity deteriorates as time passes from the first OCV being acquired. In the control flow shown in FIG. 2, the ECU 20 acquires the first OCV again after the second period P2 has elapsed since acquiring the first OCV. This enables the deterioration of the estimation precision occurring in conjunction with increase in the electric power consumption amount due to self-discharging and dark current to be suppressed each time the second period P2 elapses. The second period P2 is, for example, a period of two days to ten days.

Conventionally, the full charge capacity has been estimated from the OCV and the charging current before and after plug-in charging. However, when plug-in charging is started immediately after traveling, polarization that occurred during driving has not yet been resolved in the OCV at the start of plug-in charging, making it difficult to estimate the full charge capacity with high precision. Accordingly, in the control flow shown in FIG. 2, when the electrified vehicle 1 starts plug-in charging, the ECU 20 acquires the first OCV again after the plug-in charging ends (step S80), and then later acquires the second OCV (step S35). This enables deterioration in the precision of estimating the full charge capacity to be suppressed even when plug-in charging is started immediately after traveling.

The ECU 20 also acquires the first OCV after the plug-in charging ends and the third period P3 has elapsed (after the processing of step S70). This enables the ECU 20 to acquire the OCV after polarization that is caused by the charging current during plug-in charging has been resolved. As a result, the full charge capacity can be estimated based on the OCV from which the influence of polarization has been removed, and accordingly the precision of estimating the full charge capacity can be suppressed from deteriorating.

Here, the third period P3 is 30 minutes or 1 hour, for example. The ECU 20 may have a map indicating the relation between the temperature of the power storage cells 43 and the polarization resolution time, and may select the third period P3 based on temperature information of the power storage cells 43 that are measured by the temperature sensor 53.

Estimation of the full charge capacity according to the present disclosure is calculated based on the first OCV, the second OCV, and the integrated current value, but the present disclosure is not limited to this. Estimation of the full charge capacity may be calculated based on, for example, the first OCV, the second OCV, the integrated current value, and internal current. The term “internal current” refers to an internal current that flows within the power storage modules 42. More specifically, the internal current includes the self-discharging current of the power storage cells 43, the discharge current flowing through discharge resistance that the equalization circuits 44 have to equalize the power storage cells 43, and the current that is supplied to the monitoring ICs 45 from each of the power storage cells 43. The ECU 20 may store information regarding the internal current in advance, and calculate the amount of electric power consumption based on the internal current between the first OCV and the second OCV. ECU 20 can suppress deterioration in the estimation precision of the full charge capacity by estimating the full charge capacity based on the first OCV, the second OCV, and the total electric power consumption that is the sum of the electric power consumption based on the internal current and the integrated current value.

The information based on the internal current is the electric power consumption of the battery pack 41, which is consumed by the internal current. Information of the electric power consumption of the battery pack 41 that is consumed by the internal current includes, for example, information regarding electric power consumption based on a relation between the SOC and self-discharging current of each of the power storage cells 43, information regarding electric power consumption based on a relation between state of health (SOH) and self-discharging current of each of the power storage cells 43, information regarding electric power consumption based on a relation between the temperature and self-discharging current of each of the power storage cells 43, and so forth. Further, the information includes information regarding the electric power consumption that is consumed by the monitoring ICs 45 in the power storage device 40, and information regarding the electric power consumption based on a relation between variance in SOC of each of the power storage cells 43 and the discharge current flowing through the discharge resistance to equalize the SOCs of each of the power storage cells 43.

### Example of Full Charge Capacity Estimation

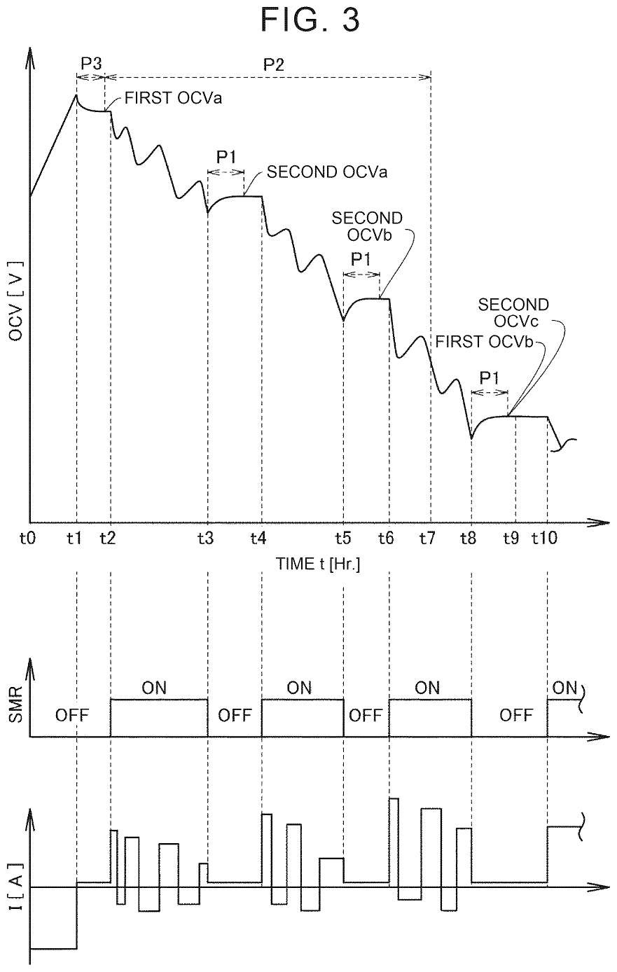

FIG. 3 shows the OCV and the current value of the power storage device 40, and the open/closed state of the SMR 14, at each time. Based on the instance shown in FIG. 3, a specific example of calculation of the full charge capacity that is performed by the electrified vehicle 1 will be shown.

At time t1, the electrified vehicle 1 ended plug-in charging. The ECU 20 acquired a first OCVa when the third period P3 elapsed from time t1. At time t2, the electrified vehicle 1 turned on the SMR 14 and also started traveling. At time t3, the electrified vehicle 1 turned off the SMR 14 and also ended traveling. The ECU 20 acquired a second OCVa when the first period P1 elapsed from time t3. The ECU 20 then calculated the full charge capacity of the battery pack 41 based on the first OCVa, the second OCVa, and the integrated current value from when the first OCVa was acquired to when the second OCVa was acquired.

At time t4, the electrified vehicle 1 turned on the SMR 14 again and also started traveling. At time t5, the electrified vehicle 1 turned off the SMR 14 and also ended traveling. The ECU 20 acquired a second OCVb when the first period P1 elapsed from time t5. The ECU 20 then calculated the full charge capacity of the battery pack 41 based on the first OCVa, the second OCVb, and the integrated current value from when the first OCVa was acquired to when the second OCVb was acquired.

At time t6, the electrified vehicle 1 turned on the SMR 14 again and also started traveling. At time t8, the electrified vehicle 1 turned off the SMR 14 and also ended traveling. The ECU 20 acquired a second OCVc when the first period P1 elapsed from time t8. The ECU 20 then calculated the full charge capacity of the battery pack 41 based on the first OCVa, the second OCVc, and the integrated current value from when the first OCVa was acquired to when the second OCVc was acquired.

At time t9, immediately after calculating the full charge capacity, the ECU 20 confirmed that the second period P2 had elapsed from when the first OCVa was acquired. The ECU 20 confirmed that the SMR 14 was OFF and that, at time t9, the first period P1 had elapsed from time t8, and stored the OCV at the time when the first period P1 elapsed from time t8, as a first OCVb.

At time t10, the electrified vehicle 1 turned on the SMR 14 again and also started traveling. Thereafter, in conjunction with the traveling of the electrified vehicle 1 ending, the ECU 20 acquires the second OCV again. The ECU 20 calculates the full charge capacity of the battery pack 41 based on the first OCVb, the second OCV that is acquired again, and the integrated current value from when the first OCVb was acquired to when acquiring the second OCV again.

The ECU 20 according to the embodiment of the present disclosure acquires the second OCV every time the electrified vehicle 1 ends traveling. This increases the difference between the first OCV and the second OCV, which are the basis for calculating the full charge capacity, and thus enables the influence of polarization and the like on the estimation precision to be suppressed. As a result, deterioration in precision of estimating the full charge capacity can be suppressed.

The embodiment disclosed herein should be interpreted as exemplary in all respects and not restrictive. The scope of the present disclosure is set forth in the claims, rather than by the above description of the embodiment, and is intended to include all modifications within the meaning and scope equivalent to the claims.

What is claimed is:

1. An electrified vehicle comprising:
a power storage device that is installed in the electrified vehicle;
a drive device that generates a driving force for traveling, using electric power that is supplied from the power storage device;
a relay that is provided between the power storage device and the drive device;
a voltage sensor that measures a voltage of the power storage device;
a current sensor that measures a charging and discharging current of the power storage device; and
a control unit, wherein the control unit
acquires a first open circuit voltage (OCV) when the relay is off,
the control unit turns on the relay at least once, and then acquires a second OCV when the relay is turned off,
calculates an integrated current value of the power storage device for a period from when the first OCV is acquired to when the second OCV is acquired, based on a measurement value from the current sensor, and
calculates full charge capacity of the power storage device based on the integrated current value, the first OCV, and the second OCV.

2. The electrified vehicle according to claim 1, wherein the control unit acquires the second OCV after a first period elapses following the relay being turned off.

3. The electrified vehicle according to claim 1, wherein, when a second period elapses after acquiring of the first OCV, the control unit acquires the first OCV again.

4. The electrified vehicle according to claim 1, wherein the control unit acquires the first OCV following the electrified vehicle ending plug-in charging.

5. The electrified vehicle according to claim 4, wherein the control unit acquires the first OCV after a third period elapses following the electrified vehicle ending plug-in charging.

6. The electrified vehicle according to claim 1, wherein:
the current sensor is provided outside of the power storage device;
the power storage device includes a power storage module; and
the control unit
stores information regarding an internal current flowing in the power storage module, and
calculates the full charge capacity of the power storage device based on the internal current, the integrated current value, the first OCV, and the second OCV.
